(19) United States
(12) Patent Application Publication
(10) Pub. No.: US 2005/0015598 A1
(43) Pub. Date: Jan. 20, 2005

(54) Method and system for providing perimeter security

(75) Inventors: Mary I. Grilliot, Dayton, OH (US); William L. Grilliot, Dayton, OH (US)

Correspondence Address: WOOD, PHILLIPS, KATZ, CLARK & MORTIMER, 500 W. MADISON STREET, SUITE 3800, CHICAGO, IL, 60661, US

(73) Assignee: Morning Pride Manufacturing, L.L.C.

(21) Appl. No.: 10/619,161

(22) Filed: Jul. 14, 2003

(51) Int. Cl. H04L 9/00

(52) U.S. Cl. 713/172

(57) ABSTRACT

In a method and a related system for providing perimeter security so as to restrict entry to authorized persons among a larger group of persons, not all of whom may be authorized, a token is issued to each person of the larger group. The token displays or identifies a unique set of electronically readable data identifying that person, who can present the token when seeking entry. Moreover, a photograph image of each person of the larger population is entered into a database, which is maintained in a computer having a display, preferably a portable or hand-held computer. The data displayed or recorded by each token presented by a person seeking entry are read, via an electronic reader, and the read data are sent to the computer. The sent data are compared to the database, via the computer, and the photographic image entered on the database of the person identified by the sent data is displayed, via the display.

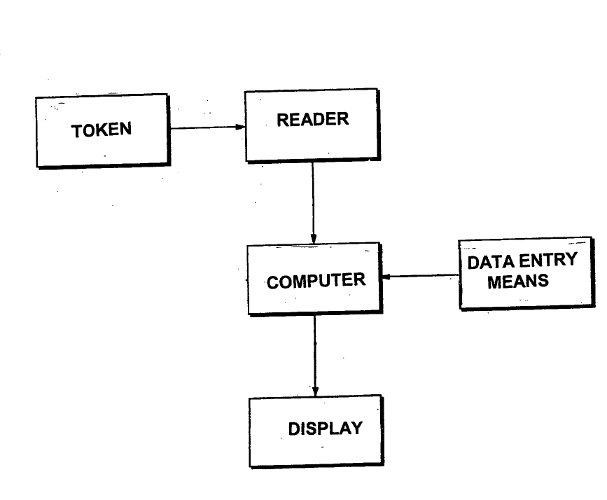

### TECHNICAL FIELD OF THE INVENTION

This invention pertains to a method and a related system for providing perimeter security, as at a firefighting site, at a military site, at a transportation site, such as an airport or a train station, at a theme park, in an office building, or elsewhere. This invention contemplated that unique data displayed or recorded by a token, such as a card, a badge, or a ticket, which is presented by a person seeking entry, are read electronically, that the read data are compared to a database, via a computer having a display, and that a photographic image entered on the database of the person identified by the read data is displayed, via the display.

### BACKGROUND OF THE INVENTION

Since terrorist attacks in the United States on Sep. 11, 2001, perimeter security has become a heightened concern at firefighting sites, particularly at firefighting sites where numerous firefighters are called upon, all of whom may not be personally acquainted with one another. Additionally, perimeter security has become a heightened concern at transportation sites, such as airports and train stations, at stadium events, at theme parks, in office buildings, and elsewhere. Historically, perimeter security has been a paramount concern at military sites, particularly at military sites where numerous military personnel are gathered.

Commonly, perimeter security has been addressed by issuing to each person authorized to enter a token, such as a card, a badge, or a ticket, which displays or records a unique set of data identifying said person, who can present the token when seeking to enter. The data are read by a human guard, if the data can be visually read, or by an electronic reader, if the data can be electronically read.

With printed cards, printed tickets, and other simple tokens, the data are susceptible to tampering or counterfeiting. As exemplified in numerous patents including U.S. Pat. No. 5,214,699, No. 5,259,025, and No. 5,268,993, more complex tokens having electronic circuits to thwart tampering with the data on such tokens have been developed.

### SUMMARY OF THE INVENTION

This invention provides a method and a related system for providing perimeter security so as to restrict entry to authorized persons, who may be among a larger group of persons, not all of whom may be authorized. A token is issued to each authorized person or to each person of the larger group. The token displays or identifies a unique set of electronically readable data identifying that person, who can present the token when seeking entry. Moreover, a photographic image of each person of the larger population is entered into a database, which is maintained in a computer having a display, preferably a portable or hand-held computer. The data displayed or recorded by each token presented by a person seeking entry are read, via an electronic reader, and the read data are sent to the computer. The sent data are compared to the database, via the computer, and the photographic image entered on the database of the person identified by the sent data is displayed, via the display.

### BRIEF DESCRIPTION OF THE DRAWING

The drawing, which comprises a single FIGURE, is a flow chart illustrating a preferred mode for carrying out this invention.

### DETAILED DESCRIPTION OF THE PREFERRED MODE

Broadly, a method and a related system are provided for providing perimeter security so as to restrict entry to authorized persons. If all persons of a group are authorized, a token is issued to each person of the group. If the authorized persons are from a larger group of persons, not all of whom may be authorized, such a token is issued to each person of the larger group. In either instance, the token displays or records a unique set of electronically readable data identifying the person to whom the token has been issued, and who can present the token when seeking entry.

The token may be a card, a badge, a ticket or any other similar or dissimilar token. The token may display alphanumeric data, bar code data, a photographic image, and other similar and dissimilar data, which can be visually read. The token may record electronically readable data, as on an embedded chip or on a magnetic strip, which cannot be visually read.

A photograph image of each authorized person is entered into a database, which is maintained in a computer having a display, via data entry means. The data displayed or recorded by each token presented by a person seeking entry are read, via an electronic reader, are sent to the computer. The computer is programmed to compare the sent data to the database and to display, via the display, the photographic image entered on the database of the person identified by the sent data. Thus, a human guard can compare the appearance of the person presenting the token to the photographic image that is displayed, before deciding whether to allow the person resenting the token to enter.

In the preferred mode for carrying out this invention, the token is an identification card, the electronically readable data are bar code data, the electronic reader is a bar code reader, which is connected operatively to the computer, and the data entry means is a digital camera, which is connected operatively to the computer. The bar code reader and the digital camera may be operatively connected to the computer via wired or wireless connections.

If the database is replicated on numerous computers, such as hand-held or portable computers carried by different personnel, it is difficult to an unauthorized person seeking entry to defeat the system, even if the unauthorized person is able to compromise the database maintained on some computers and to present a counterfeit, facially credible token, as the unauthorized person risks being detected via the database maintained on another computer. In a suspicious case, the data displayed or recorded on the token presented by a person seeking entry may be compared to the database maintained on each of plural computers.

1. A method for providing perimeter security so as to restrict entry to authorized persons, wherein the method comprises steps of
(a) issuing to each authorized person a token displaying or recording a unique set of electronically readable data identifying said authorized person, who can present the token when seeking entry,
(b) entering a photograph image of each authorized person into a database, which is maintained in a computer having a display,
(c) reading the data displayed or recorded by each token presented by a person seeking entry, via an electronic reader, and sending the read data to the computer,
(d) comparing the sent data to the database, via the computer, and displaying the photographic image entered on the database of the person identified by the sent data, via the display.

2. A method for providing perimeter security so as to restrict entry to authorized persons among a larger group of persons, not all of whom may be authorized, wherein the method comprises steps of
(a) issuing to each person of the larger group a token displaying or recording a unique set of electronically readable data identifying said person, who can present the token when seeking entry,
(b) entering a photograph image of each person of the larger population into a database, which is maintained in a computer having a display,
(c) reading the data displayed or recorded by each token presented by a person seeking entry, via an electronic reader, and sending the read data to the computer,
(d) comparing the sent data to the database, via the computer, and displaying the photographic image entered on the database of the person identified by the sent data, via the display.

3. The method of claim 1 or 2, wherein the computer is a portable or hand-held computer.

4. The method of claim 1 or 2, wherein the computer is one of plural portable or hand-held computers, each of which maintains a replica of the database.

5. A system for providing perimeter security so as to restrict entry to authorized persons, wherein the system comprises
(a) tokens, each of which is issued to an authorized person and each of which displays or record a unique set of electronically readable data identifying the authorized person to whom it has been issued, and who can present the token issued to said person when seeking entry,
(b) a computer having a display and maintaining a database, into which has been entered a photograph image of each person to whom one of has been issued, and
(c) means including an electronic reader for reading the data displayed or recorded by each token presented by a person seeking entry and for sending the read data to the computer,
wherein the computer is programmed to compare the sent data to the database and to display, via the display, the photographic image entered on the database of the person identified by the sent data.

6. A system for providing perimeter security so as to restrict entry to authorized persons from a larger group of persons, not all of whom may be authorized, wherein the system comprises
(a) tokens, each of which is issued to a specific person of the larger group and each of which displays or record a unique set of electronically readable data identifying the specific person, who can present the token issued to said person when seeking entry,
(b) a computer having a display and maintaining a database, into which has been entered a photograph image of each person to whom one of the tokens has been issued, and
(c) means including an electronic reader for reading the data displayed or recorded by each token presented by a person seeking entry and for sending the read data to the computer,
wherein the computer is programmed to compare the sent data to the database and to display, via the display, the photographic image entered on the database of the person identified by the sent data.

7. The method of claim 5 or 6, wherein the computer is a portable or hand-held computer.

8. The method of claim 5 or 6, wherein the computer is one of plural portable or hand-held computers, each of which maintains a replica of the database.
